(19) United States
(12) Patent Application Publication
(10) Pub. No.: US 2026/0120668 A1
(43) Pub. Date: Apr. 30, 2026

(54) ELECTRONIC MUSICAL INSTRUMENT, PROCESSING EXECUTION METHOD, AND PROCESSING EXECUTION PROGRAM

(71) Applicant: Roland Corporation, Shizuoka (JP)

(72) Inventors: Takashi Nishimura, Hamamatsu (JP); Takeshi Isogawa, Shizuoka (JP)

(73) Assignee: Roland Corporation, Shizuoka (JP)

(21) Appl. No.: 19/212,578

(22) Filed: May 19, 2025

(30) Foreign Application Priority Data
Oct. 31, 2024 (JP) 2024-191635

(51) Int. Cl. G10H 1/18

(52) U.S. Cl. CPC G10H 1/18; G10H 2210/165; G10H 2210/185; G10H 2210/225; G10H 2220/221

(57) ABSTRACT

Provided are an electronic musical instrument, a processing execution method, and a processing execution program capable of quickly performing registration to a key group based on key depression from key depression, and special processing based on keys registered to the key group. In a case where the depressed position of a key 2a is between a determination start position D3 and a determination end position D4, the key 2a is registered to a key group. Registration of the key 2a to the key group can be quickly determined by only confirming the depressed position of the key 2a. In a case where a key 2a registered to the key group reaches a sound generation start position Ds, and the registration number in the key group at that point is two or more, a musical note with a special tone based on that key 2a is generated. Therefore, the time lag from the registration of the key 2a to the key group to the start of sound generation based on the key 2a registered to the key group is minimized, making it possible to quickly register a key 2a to the key group based on key depression from key depression, and generate a musical note based on the key 2a registered to the key group.

### CROSS-REFERENCE TO RELATED APPLICATION

This application claims the priority benefit of Japanese application serial no. 2024-191635, filed on Oct. 31, 2024. The entirety of the above-mentioned patent application is hereby incorporated by reference herein and made a part of this specification.

### TECHNICAL FIELD

The disclosure relates to an electronic musical instrument, a processing execution method, and a processing execution program.

### BACKGROUND ART

Patent Document 1 discloses an electronic musical instrument that determines whether a chord or a single note has been input when a key is depressed. Specifically, whether a chord or a single note has been input is determined based on whether a key-on event from multiple keys has occurred within a predetermined time T.

### RELATED ART DOCUMENTS

### Patent Documents

[Patent Document 1] Japanese Patent Application Laid-Open No. H6-250655 However, in Patent Document 1, a chord/single note is determined after the predetermined time T has elapsed from when the user depresses a key, so there is a time lag of at least the predetermined time T from the key depression to the start of sound generation of a musical note. The user may feel discomfort with such a time lag, which is a problem for it makes comfortable performance not possible.

The disclosure provides an electronic musical instrument, a processing execution method, and a processing execution program that are capable of quickly performing registration to a key group based on key depression from key depression, and special processing based on keys registered to the key group.

### SUMMARY

An electronic musical instrument according to an embodiment of the disclosure includes a keyboard having a plurality of keys. The electronic musical instrument includes: a registration part that, after a key is depressed, registers the key to a key group in a case where a depressed position of the key is between a determination start position and a determination end position which is a position lower than the determination start position; a normal processing execution part that, in a case where a depressed position of a key not registered to the key group reaches an execution start position which is a position at or below the determination end position, or in a case where a depressed position of a key registered to the key group reaches the execution start position in a state where the number of keys registered to the key group is one, executes normal processing based on these keys; and a special processing execution part that, in a case where a depressed position of a key registered to the key group reaches the execution start position in a state where the number of keys registered to the key group is two or more, executes special processing which is special processing based on the key and is different from the normal processing.

A processing execution method according to an embodiment of the disclosure is a method executed in an electronic musical instrument including a keyboard having a plurality of keys. The processing execution method includes: after a key is depressed, registering the key to a key group in a case where a depressed position of the key is between a determination start position and a determination end position which is a position lower than the determination start position; in a case where a depressed position of a key not registered to the key group reaches an execution start position which is a position at or below the determination end position, or in a case where a depressed position of a key registered to the key group reaches the execution start position in a state where the number of keys registered to the key group is one, executing normal processing based on these keys; and in a case where a depressed position of a key registered to the key group reaches the execution start position in a state where the number of keys registered to the key group is two or more, executing special processing which is special processing based on the key and is different from the normal processing.

Further, a processing execution program according to an embodiment of the disclosure is a program that causes a computer including a keyboard having a plurality of keys to execute processing based on the key depressed. The processing execution program causes the computer to: after a key is depressed, register the key to a key group in a case where a depressed position of the key is between a determination start position and a determination end position which is a position lower than the determination start position; in a case where a depressed position of a key not registered to the key group reaches an execution start position which is a position at or below the determination end position, or in a case where a depressed position of a key registered to the key group reaches the execution start position in a state where the number of keys registered to the key group is one, execute normal processing based on these keys; and in a case where a depressed position of a key registered to the key group reaches the execution start position in a state where the number of keys registered to the key group is two or more, execute special processing which is special processing based on the key and is different from the normal processing.

### BRIEF DESCRIPTION OF THE DRAWINGS

FIG. 1 is a diagram showing the external appearance of a synthesizer.

(a) of FIG. 2 is a diagram illustrating each depressed position of a key, (b) of FIG. 2 is a diagram showing a keyboard 2 immediately after a key is depressed, and (c) of FIG. 2 is a diagram showing the keyboard 2 in a case where the position of the key reaches a sound generation start position.

FIG. 3 is a block diagram showing the electrical configuration of the synthesizer.

FIG. 4 is a functional block diagram of the synthesizer.

(a) of FIG. 5 is a flowchart of the main processing, and (b) of FIG. 5 is a flowchart of the grouping processing.

FIG. 6 is a flowchart of the sound generation processing.

(a) of FIG. 7 is a flowchart of the timer processing, and (b) of FIG. 7 is a flowchart of the muting processing.

(a) of FIG. 8 is a flowchart of the main processing in the second embodiment, and (b) of FIG. 8 is a flowchart of the grouping processing in the second embodiment.

(a) of FIG. 9 is a flowchart of the grouping disable processing in the second embodiment, and (b) of FIG. 9 is a flowchart of the muting processing in the second embodiment.

FIG. 10 is a flowchart of the grouping processing in the third embodiment.

FIG. 11 is a flowchart of the sound generation processing in the third embodiment.

(a) of FIG. 12 is a flowchart of the main processing in the fourth embodiment, and (b) of FIG. 12 is a flowchart of the chord portamento start processing in the fourth embodiment.

FIG. 13 is a flowchart of the chord portamento periodic processing in the fourth embodiment.

### DESCRIPTION OF THE EMBODIMENTS

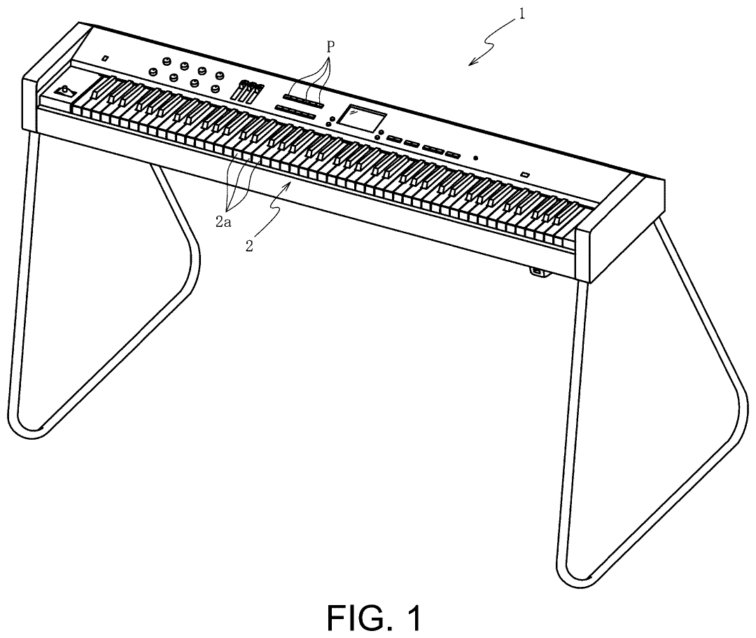

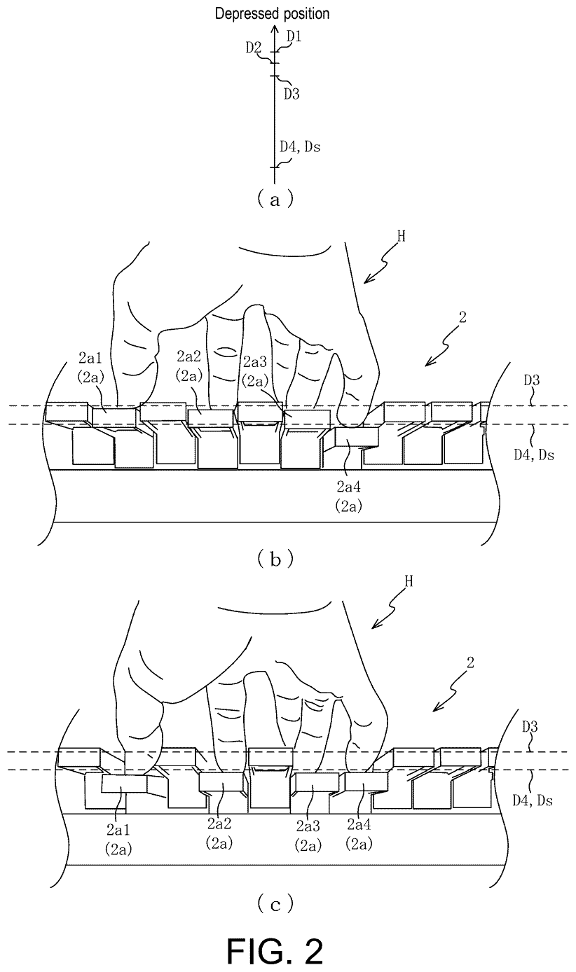

Hereinafter, exemplary embodiments will be described with reference to the attached figures. Referring to FIG. 1, the overview of a synthesizer 1 of this embodiment will be described. FIG. 1 is a diagram showing the external appearance of the synthesizer 1.

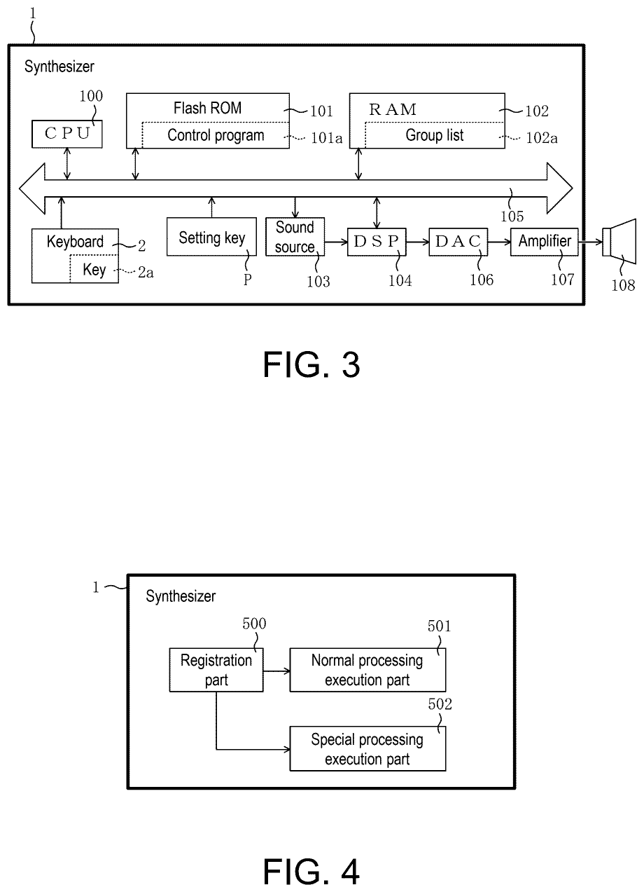

The synthesizer 1 is an electronic musical instrument that outputs (releases sounds) by mixing a musical note based on a performance operation of a user H and a predetermined accompaniment sound, etc. The synthesizer 1 mainly includes a keyboard 2 and setting keys P where various settings are input from the user H. The keyboard 2 is an input device for acquiring performance information from the performance of the user H. Multiple keys 2a are arranged on the keyboard 2, and performance information corresponding to a key depression/release operation (that is, performance operation) of the user H on the key 2a is output to a CPU 100 (see FIG. 3). The position of the key 2a in the vertical direction (that is, key depression depth, hereinafter referred to as “depressed position of the key 2a”) according to the key depression/release performance operation of the user H may be detected in stages using multiple contact switches or the like, or may be detected continuously using continuous detection sensors or the like.

In this embodiment, the key 2a is registered to a “key group” according to the depressed position of the key 2a, and in a state where the number of keys 2a registered to the key group is two or more, in response to the depressed position of a key 2a registered to the key group reaching a sound generation start position Ds, sound generation of a musical note using a tone (hereinafter referred to as “special tone”) different from the tone (hereinafter referred to as “normal tone”) normally used for that key 2a is started. Various depressed positions, such as the aforementioned sound generation start position Ds, of the key 2a used for registration to the key group and generation of the musical note based on the key 2a will be described with reference to (a) of FIG. 2.

(a) of FIG. 2 is a diagram illustrating the various depressed positions of the key 2a. In (a) of FIG. 2 and (b) of FIG. 2, the vertical axis represents the depressed position of the key 2a. In this embodiment, the depressed position of the key 2a becomes smaller (lower) as the key 2a is pushed in. In this embodiment, a key release position D1, a muting position D2, a determination start position D3, a determination end position D4, and the sound generation start position Ds are respectively set as the depressed positions of the key 2a.

The key release position D1 is a position to which the key 2a returns when moving upward in a case where the user H depresses the key 2a and then releases, and is also a position before the user H touches the key 2a. The muting position D2 is a position provided below the key release position D1. In a case where the key 2a is released and the depressed position of the key 2a is at or above the muting position D2, muting of the musical note assigned to the key 2a during sound generation is started.

The determination start position D3 is a position provided below the muting position D2, and the determination end position D4 is a position provided below the determination start position D3. In a case where a key 2a is depressed and the depressed position of the key 2a is between the determination start position D3 and the determination end position D4, the key 2a is registered to the key group.

The sound generation start position Ds is a position (execution start position) provided at the same height as the determination end position D4. In a case where the depressed position of the key 2a is at or below the sound generation start position Ds, sound generation of the musical note based on the key 2a is started. At this time, depending on whether the key 2a that reaches the sound generation start position Ds has been registered to the key group or not, and even in a case where the key 2a has been registered to the key group, depending on the number of keys 2a registered to the key group, a normal tone or a special tone is set for the musical note based on that key 2a.

Specifically, in a case where a key 2a is not registered to the key group, or in a case where a key 2a is registered to the key group but the number of keys 2a registered to the key group at that point is one, that is, no other key 2a besides that key 2a is registered to the key group, sound generation of a musical note with a normal tone (for example, piano) based on that key 2a is started. As the pitch of the musical note at this time, the pitch corresponding to the depressed key 2a is set. The start of sound generation of a musical note with such a normal tone is referred to as “normal processing.”

On the other hand, in a case where a key 2a is registered to the key group, and the number of keys 2a registered to the key group at that point is two or more, that is, other keys 2a besides that key 2a are registered to the key group, sound generation of a musical note with a special tone based on that key 2a is started. The pitch of the musical note at this time is also set to the pitch corresponding to the depressed key 2a. The start of sound generation of a musical note with such a special tone (for example, organ) is referred to as “special processing.”

In addition, since the sound generation start position Ds is set at the same height as the determination end position D4, compared to a case where these are provided at separate positions, the number of positions (points) for monitoring the depressed position of the key 2a is reduced. As a result, the monitoring of the depressed position of the key 2a can be performed quickly, making it possible to more quickly execute the registration of the key 2a to the key group and the start of sound generation of the musical note.

Furthermore, as the determination end position D4 is set at the same height as the sound generation start position Ds, the distance from the determination start position D3 to the determination end position D4 increases. Therefore, it becomes easy for the user H to simultaneously position two or more keys 2a between the determination start position D3 and the determination end position D4, which facilitates simultaneous registration of these keys 2a to the key group. Thereby, sound generation of a musical note with the special tone can be started easily.

In addition, in a case where the depressed position of a key 2a registered to the key group reaches the sound generation start position Ds, that key 2a is excluded from the key group. This prevents a key 2a whose depressed position has reached the sound generation start position Ds and has started sound generation of a musical note with the special tone from remaining registered to the key group. For example, in a case where a key 2a that has started sound generation of a musical note with the special tone is released, and then the user H depresses that key 2a alone with the intention of generating a musical note with the normal tone, a musical note with the normal tone, rather than a musical note with the special tone, is generated. Thereby, a musical note with the tone intended by the user H can be generated.

Furthermore, even if a key 2a whose depressed position has reached the sound generation start position Ds and has started sound generation of a musical note with the special tone continues to be depressed, that key 2a is excluded from the key group because the depressed position has already reached the sound generation start position Ds. Therefore, after sound generation of a musical note with the special tone based on that key 2a has started, if another key 2a is depressed with the intention of generating a musical note with the normal tone while continuing to depress only that key 2a, since the number of keys 2a registered to the key group is “one” due to another key 2a, the musical note based on another key 2a is generated using the normal tone rather than the special tone. This also allows for generation of a musical note with the tone intended by the user H.

In addition, in a case where a key 2a registered to the key group is released without reaching the sound generation start position Ds, and subsequently the depressed position becomes higher than the determination start position D3, that key 2a is excluded from the key group. This prevents a key 2a that is registered to the key group but released without the depressed position reaching the sound generation start position Ds from remaining registered to the key group.

For example, in a case where a key 2a is depressed with the depressed position lower than the determination start position D3 but is released without the depressed position reaching the sound generation start position Ds, and then the user H depresses that key 2a alone with the intention of generating a musical note with the normal tone, a musical note with the normal tone, rather than a musical note with the special tone, is generated. Thereby, a musical note with the tone intended by the user H can be generated.

Next, the registration of a key group and the start of sound generation of a musical note with the special tone will be described with reference to (b) of FIG. 2 and (c) of FIG. 2. (b) of FIG. 2 is a diagram showing the keyboard 2 immediately after keys 2a are depressed, and (c) of FIG. 2 is a diagram showing the keyboard 2 in a case where the depressed positions of the keys 2a reach the sound generation start position Ds. In (b) of FIG. 2, among the keys 2a of the keyboard 2, keys 2a1, 2a2, and 2a3 are depressed at approximately the same timing and speed, and are in a state immediately after depression where the depressed positions thereof are at or below the determination start position D3 and at or above the determination end position D4.

In addition, among the keys 2a, key 2a4 is depressed before keys 2a1, 2a2, and 2a3 are depressed, and is in a state where the depressed position thereof is at or below the sound generation start position Ds. It should be noted that during the period from the start of depressing key 2a4 until the depressed position reaches the determination end position D4, all other keys 2a except key 2a4 are not depressed, and the depressed positions thereof are near the key release position D1 as described above.

In (b) of FIG. 2, since the respective depressed positions of keys 2a1, 2a2, and 2a3 are at or below the determination start position D3 and at or above the determination end position D4, these are registered to the key group.

On the other hand, the depressed position of key 2a4 is at or below the sound generation start position Ds, and although not shown, all other keys 2a except key 2a4 are not depressed during the period from the start of depressing key 2a4 until the depressed position reaches the determination end position D4. Therefore, at the point when the depressed position of key 2a4 reaches the sound generation start position Ds, only key 2a4 is registered to the key group, so a musical note is generated with the normal tone based on key 2a4.

As the user H further pushes in keys 2a1, 2a2, and 2a3, the depressed positions of keys 2a1, 2a2, and 2a3 reach the determination end position D4 and the sound generation start position Ds ((c) of FIG. 2). This causes musical notes based on keys 2a1, 2a2, and 2a3 to be generated. At this time, since the three keys 2a1, 2a2, and 2a3 are registered to the key group, musical notes are generated with the special tone based on keys 2a1, 2a2, and 2a3.

Additionally, at this time, since key 2a4 still maintains the depressed position at or below the sound generation start position Ds, the sound generation of the musical note with the normal tone based on key 2a4 continues. Thus, the user H can simultaneously generate the musical note with the normal tone based on key 2a4 and the musical notes with the special tone based on keys 2a1, 2a2, and 2a3, without setting the tone to be used for sound generation each time through the setting keys P.

For example, by simultaneously depressing keys 2a corresponding to component sounds of a chord that serves as an accompaniment sound, and separately depressing keys 2a corresponding to the melody line as appropriate, the melody line is generated with the normal tone (for example, piano), and the accompaniment sound is generated with the special tone (for example, organ).

For such sound generation, the user H does not need to set the range and tone of keys 2a used in the melody line, and the range and tone of keys 2a used in the accompaniment sound through the setting keys P during performance. This allows the user H to easily specify the tone of the musical note to be generated, from among the normal tone and the special tone, by the timing of depressing the keys 2a.

As described above, in this embodiment, in a case where a key 2a is depressed and the depressed position thereof is between the determination start position D3 and the determination end position D4, that key 2a is registered in a key group. In other words, since it is determined whether to register the key 2a to the key group by only confirming the depressed position relationship of the depressed key 2a, there is no need to wait for a predetermined time when registering to the key group, which makes it possible to quickly register to the key group.

Then, in a case where the depressed position of a key 2a registered to the key group reaches the sound generation start position Ds, and the number of keys 2a registered to the key group at that time is two or more, sound generation of a musical note with the special tone based on that key 2a is started. Therefore, the time lag from the registration of the key 2a to the key group until the start of sound generation based on the keys 2a registered to the key group can be minimized. As a result, both the registration to the key group based on key depression and the sound generation of a musical note based on the key 2a registered to that key group can be performed quickly. This allows the user H to perform comfortably without feeling stress.

Next, the electrical configuration of the synthesizer 1 will be described with reference to FIG. 3. FIG. 3 is a block diagram showing the electrical configuration of the synthesizer 1. The synthesizer 1 includes a CPU 100, a flash ROM 101, a RAM 102, the keyboard 2 and setting keys P described above, a sound source 103, and a DSP (Digital Signal Processor) 104, which are connected respectively via a bus line 105. A DAC (Digital Analog Converter) 106 is connected to the DSP 104, an amplifier 107 is connected to the DAC 106, and a speaker 108 is connected to the amplifier 107.

The CPU 100 is a computing device that controls each part connected by the bus line 105. The flash ROM 101 is a rewritable non-volatile memory and has a control program 101a. When the control program 101a is executed by the CPU 100, the main processing of (a) of FIG. 5 is executed. The RAM 102 is a memory that rewritably stores various work data and flags when the CPU 100 executes programs such as the control program 101a, and a group list 102a is provided where the information of the keys 2a registered to the key group is stored.

The sound source 103 is a device that outputs waveform data according to performance information input from the CPU 100. The DSP 104 is a computing device for computing and processing waveform data input from the sound source 103. The DAC 106 is a conversion device that converts the waveform data input from the DSP 104 into analog waveform data. The amplifier 107 is an amplification device that amplifies the analog waveform data output from the DAC 106 at a predetermined gain. The speaker 108 is an output device that releases (outputs) the analog waveform data amplified by the amplifier 107 as a musical note.

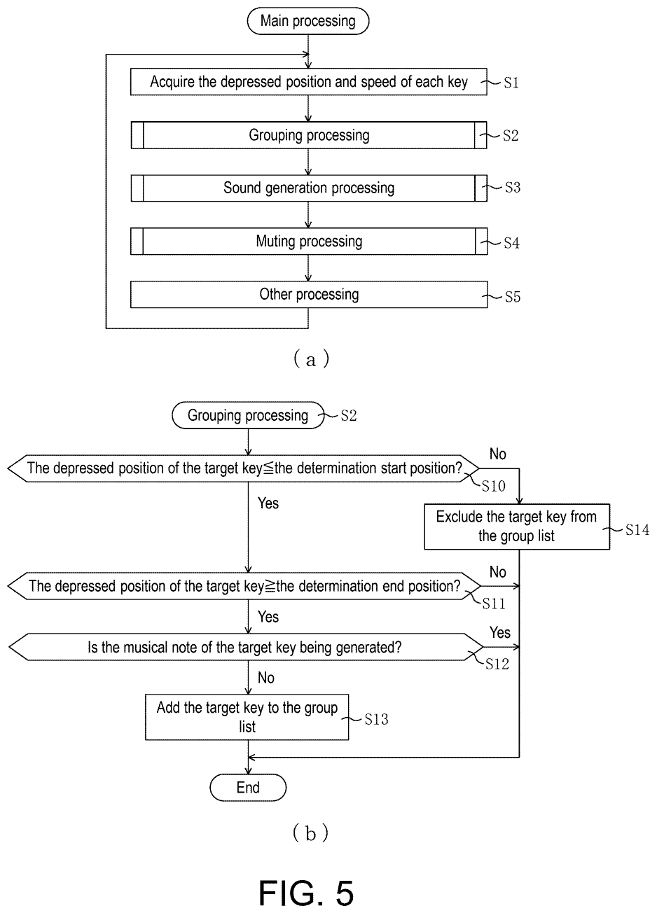

Next, the functions of the synthesizer 1 will be described with reference to FIG. 4. FIG. 4 is a functional block diagram of the synthesizer 1. As shown in FIG. 4, the synthesizer 1 includes a registration part 500, a normal processing execution part 501, and a special processing execution part 502.

The registration part 500 is a part that in a case where, after a key 2a is depressed, the depressed position of that key 2a is between the determination start position D3 and the determination end position D4, registers that key 2a to a key group, and is realized by the CPU 100 described above in FIG. 3. The normal processing execution part 501 is a part that in a case where the depressed position of a key 2a not registered to the key group reaches the sound generation start position Ds, or in a case where the depressed position of a key 2a registered to the key group reaches the sound generation start position Ds in a state where the number of keys 2a registered to the key group is one, executes normal processing based on these keys 2a, and is realized by the CPU 100. In addition, the special processing execution part 502 is a part that in a case where a key 2a registered to the key group reaches the sound generation start position Ds in a state where the number of keys 2a registered to the key group is two or more, executes special processing based on that key 2a, and is realized by the CPU 100.

That is to say, in a case where the depressed position of a key 2a is between the determination start position D3 and the determination end position D4, that key 2a is registered to the key group. In other words, since it is determined whether to register a key 2a to the key group by only confirming the depressed position of the depressed key 2a, there is no need to wait for a predetermined time when registering to the key group, which makes it possible to quickly register to the key group.

Then, in a case where the depressed position of a key 2a registered to the key group reaches the sound generation start position Ds in a state where the number of keys 2a registered to the key group is two or more, special processing based on that key 2a is executed. Therefore, from the depression of the key 2a, the registration to the key group based on the key depression, and the execution of the special processing based on the key 2a registered in that key group can be performed quickly.

Next, the processing executed by the CPU 100 will be described with reference to (a) of FIG. 5 and (b) of FIG. 5 to (a) of FIG. 7 and (b) of FIG. 7. (a) of FIG. 5 is a flowchart of the main processing. The main processing is processing executed when the power of the synthesizer 1 is turned on. The main processing first acquires the depressed position and speed of each key 2a provided on the keyboard 2 (S1).

After the processing of S1, grouping processing (S2), sound generation processing (S3), and muting processing (S4) are executed in sequence. It should be noted that the processing of S2 to S4 is executed for each key 2a. After the muting processing of S4, other processing (S5) of the synthesizer 1 is executed, and the processing from S1 onward is repeated. Here, the grouping processing, sound generation processing, and muting processing, as well as the processing associated with these, will be described with reference to (b) of FIG. 5 to (a) of FIG. 7 and (b) of FIG. 7.

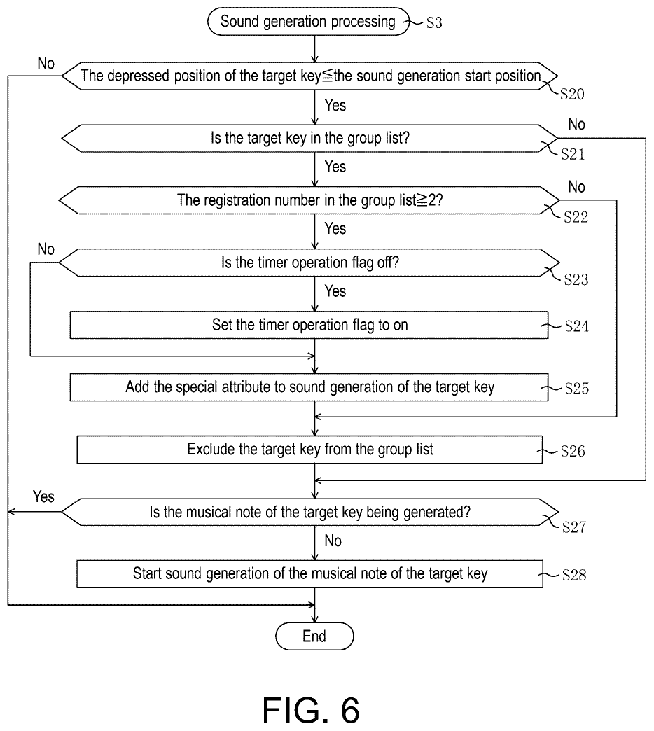

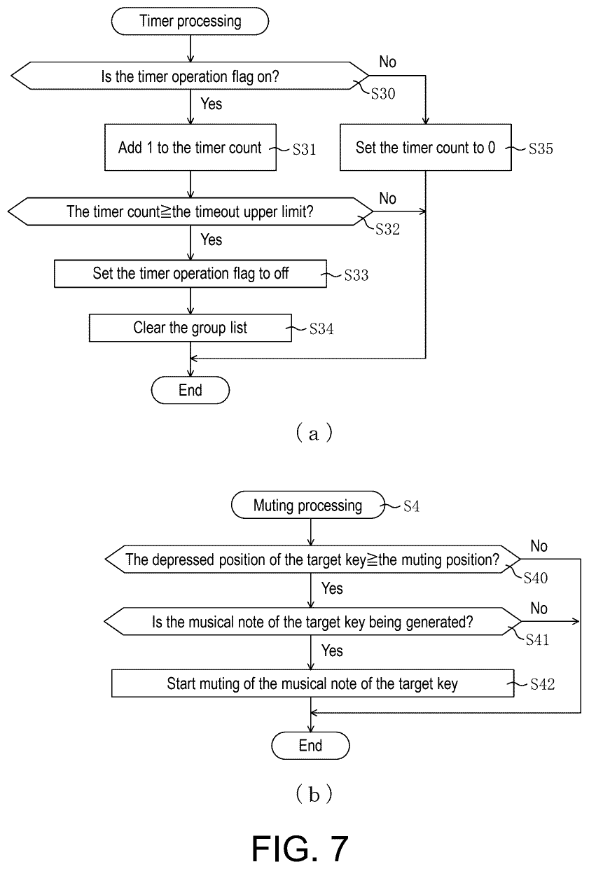

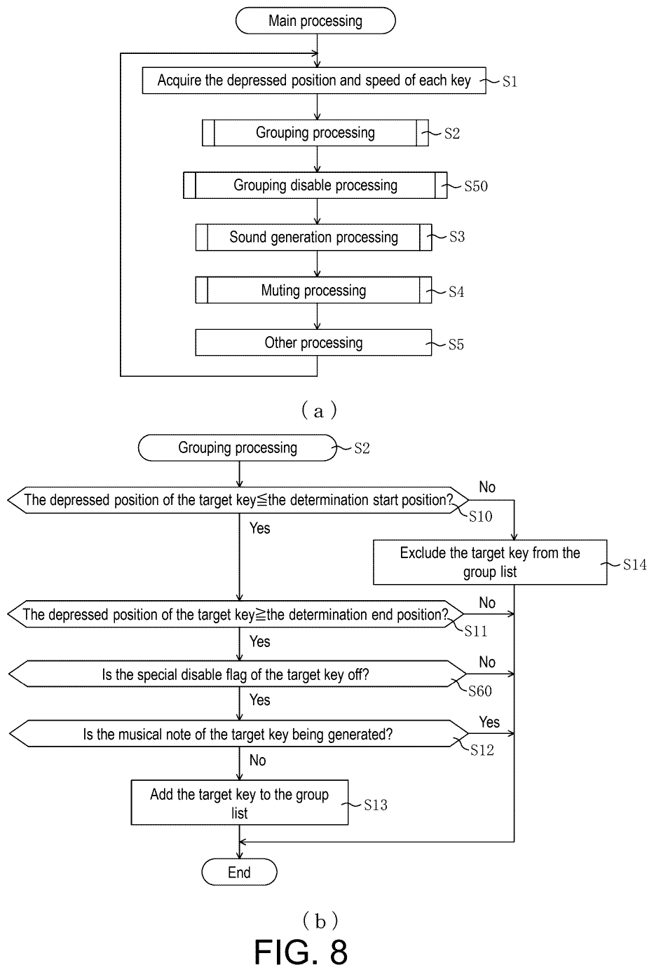

(b) of FIG. 5 is a flowchart of the grouping processing. The grouping processing is processing that, according to the depressed position of a target key 2a, registers that key 2a to a key group or excludes that key 2a from the key group. Hereinafter, the target key 2a in the grouping processing will be abbreviated as “target key 2a,” and the same applies to FIG. 6, (b) of FIG. 7, (b) of FIG. 8, (a) of FIG. 9 and (b) of FIG. 9 to FIG. 11.

The grouping processing first confirms whether the depressed position of the target key 2a is at or below the determination start position D3 (S10). In the processing of S10, in a case where it is confirmed that the depressed position of the target key 2a is at or below the determination start position D3 (S10: Yes), it is further confirmed whether the depressed position of the target key 2a is at or above the determination end position D4 (S11). In the processing of S11, in a case where it is confirmed that the depressed position of the target key 2a is at or above the determination end position D4 (S11: Yes), it is confirmed whether the musical note based on the target key 2a is being generated (S12).

In the processing of S12, in a case where it is confirmed that the musical note based on the target key 2a is not being generated (S12: No), the information of the target key 2a is added to the group list 102a (S13). This adds the target key 2a to the key group. On the other hand, in the processing of S12, in a case where it is confirmed that the musical note based on the target key 2a is being generated (S12: Yes), the processing of S13 is skipped.

Thus, in a case where the musical note based on the target key 2a is being generated, the addition of the information of that key 2a to the group list 102a is omitted. For example, as the musical note is already being generated with the normal tone, and the depressed position of that key 2a is at or below the determination start position D3 and at or above the determination end position D4, it is possible to prevent the tone from changing to the special tone, allowing the musical note to be generated with the tone intended by the user H.

In the processing of S11, in a case where it is confirmed that the depressed position of the target key 2a is lower than the determination end position D4 (S11: No), the processing of S12 and S13 is skipped. Also, in the processing of S10, in a case where it is confirmed that the depressed position of the target key 2a is higher than the determination start position D3 (S10: No), the information of the target key 2a is excluded from the group list 102a (S14). After the processing of S13 and S14, the grouping processing is terminated.

Next, the sound generation processing of S3 will be described with reference to FIG. 6. FIG. 6 is a flowchart of the sound generation processing. The sound generation processing is processing that starts the generation of a musical note based on the target key 2a. The sound generation processing first confirms whether the depressed position of the target key 2a is at or below the sound generation start position Ds (S20). In the processing of S20, in a case where it is confirmed that the depressed position of the target key 2a is at or below the sound generation start position Ds (S20: Yes), it is confirmed whether the information of the target key 2a is in the group list 102a (S21).

In the processing of S21, in a case where it is confirmed that the information of the target key 2a is in the group list 102a (S21: Yes), it is confirmed whether the number of key 2a information registered in the group list 102a is two or more (S22).

In the processing of S22, in a case where it is confirmed that the number of key 2a information registered in the group list 102a is two or more (S22: Yes), it is confirmed whether a timer operation flag is off (S23).

Here, the timer operation flag is a flag that stores the state of whether a timer is operating, which starts timing when information of keys 2a is stored in the group list 102a that is in a state where no information of key 2a is stored (that is, unregistered state), and subsequently, the depressed position of any of the keys 2a whose information is stored in the group list 102a first reaches the sound generation start position Ds. The timer operation flag is set to on in a case where the timer is operating, and is set to off in a case where the timer is not operating.

For example, from a state where no information of key 2a is stored in the group list 102a, the information of keys 2a1, 2a2, and 2a3 is sequentially stored in the group list 102a, and when the depressed position of key 2a1 among these first reaches the sound generation start position Ds ahead of keys 2a2 and 2a3, the timer operation flag is set to on, and timing of the timer is started. The setting of the timer operation flag will be described later in (a) of FIG. 7.

In the processing of S23, a case where the timer operation flag is off (S23: Yes) is a timing when information of keys 2a is stored in the group list 102a where no information of key 2a is stored, and among the keys 2a stored in that group list 102a, the depressed position of the target key 2a first reaches the sound generation start position Ds, and a musical note based on that key 2a is generated, so the timer operation flag is set to on (S24). On the other hand, in the processing of S23, in a case where the timer operation flag is on (S23: No), the processing of S24 is skipped.

After the processing of S23 and S24, a special attribute is added to the sound generation of the musical note based on the target key 2a (S25). The special attribute is information that instructs to use a special tone for the musical note based on the target key 2a. In a case where the special attribute is added, the special tone is used for the musical note based on the target key 2a, and in a case where the special attribute is not added, the normal tone is used for the musical note.

In the processing of S22, in a case where it is confirmed that the number of key 2a information registered in the group list 102a is less than two (S22: No), the processing of S23 to S25 is skipped. After the processing of S22 and S25, the information of the target key 2a is excluded from the group list 102a (S26).

In the processing of S21, in a case where it is confirmed that the information of the target key 2a is not in the group list 102a (S21: No), the processing of S22 to S26 is skipped. After the processing of S21 and S26, it is confirmed whether the musical note based on the target key 2a is being generated (S27). In the processing of S27, in a case where it is confirmed that the musical note based on the target key 2a is not being generated (S27: No), the sound generation of the musical note based on the target key 2a is started (S28). At this time, due to the processing of S25, a special tone is used for the musical note based on the target key 2a in a case where the special attribute is added, and a normal tone is used for the musical note based on the target key 2a in a case where the special attribute is not added.

On the other hand, in the processing of S27, in a case where it is confirmed that the musical note based on the target key 2a is being generated (S27: Yes), the processing of S28 is skipped. Also, in the processing of S20, in a case where it is confirmed that the depressed position of the target key 2a is higher than the sound generation start position Ds (S20: No), the processing of S21 to S28 is skipped. After the processing of S20, S27, and S28, the sound generation processing is terminated.

Here, the timer processing will be described with reference to (a) of FIG. 7. The timer processing is processing executed every 1 millisecond after the power of the synthesizer 1 is turned on, and is processing executed in parallel with the main processing described above. The interval at which the timer processing is executed is not limited to 1 millisecond, and may be more than 1 millisecond or less than 1 millisecond.

The timer processing first confirms whether the timer operation flag described above in FIG. 6 is on (S30). In the processing of S30, in a case where it is confirmed that the timer operation flag is on (S30: Yes), 1 is added to the timer count (S31). The timer count is a value corresponding to the elapsed time in the above-mentioned timer, and for example, in a case where the timer count is 1, it indicates that 1 millisecond has elapsed since the timer starts timing.

After the processing of S31, it is confirmed whether the timer count is equal to or more than the timeout upper limit (S32). In this embodiment, “15” is set as the timeout upper limit. In the processing of S31, the timer starts timing, that is, information of keys 2a is stored in the group list 102a where no information of key 2a is stored, and then it is confirmed whether 15 milliseconds (first time) have elapsed since the depressed position of any of the keys 2a stored in the group list 102a first reaches the sound generation start position Ds (FIG. 6, S23 to S28). The timeout upper limit is not limited to 15, and may be more than 15 or less than 15.

In the processing of S32, in a case where it is confirmed that the timer count is equal to or more than the timeout upper limit (S32: Yes), the timer operation flag is set to off (S33), and the group list 102a is cleared (S34).

In other words, in a case where information of keys 2a is stored in the group list 102a where no information of key 2a is stored, and then 15 milliseconds have elapsed since the depressed position of any of the keys 2a whose information is stored in the group list 102a first reaches the sound generation start position Ds, the group list 102a is cleared. Therefore, even for a series of keys 2a that have been stored in the group list 102a once and registered to a key group, if 15 milliseconds have elapsed since the depressed position of the first key 2a reaches the sound generation start position Ds, the remaining keys 2a registered to the key group are excluded from the key group, and the normal tone rather than the special tone is used for the musical notes based on the remaining keys 2a.

This allows the user H to easily specify the key 2a that generates a musical note with a special tone and the key 2a that generates a musical note with a normal tone, among the keys 2a registered to the key group, by adjusting the timing of pushing the depressed positions of a series of keys 2a registered to the key group to or below the sound generation start position Ds.

In the processing of S32, in a case where it is confirmed that the timer count is less than the timeout upper limit (S32: No), the processing of S33 and S34 is skipped. In the processing of S30, in a case where it is confirmed that the timer operation flag is off (S30: No), the timer count is set to 0 (S35). After the processing of S34 and S35, the timer processing is terminated.

Next, the muting processing of S4 will be described with reference to (b) of FIG. 7. The muting processing is processing that mutes the musical note based on the target key 2a which is being generated in a case where the depressed position of the target key 2a is at or above the muting position D2. The muting processing first confirms whether the depressed position of the target key 2a is at or above the muting position D2 (S40). In the processing of S40, in a case where it is confirmed that the depressed position of the target key 2a is at or above the muting position D2 (S40: Yes), it is confirmed whether the musical note based on the target key 2a is being generated (S41).

In the processing of S41, in a case where it is confirmed that the musical note based on the target key 2a is being generated (S41: Yes), the muting of the musical note based on the target key 2a is started (S42). On the other hand, in the processing of S31, in a case where it is confirmed that the musical note based on the target key 2a is not being generated (S41: No), the processing of S42 is skipped. In the processing of S40, in a case where it is confirmed that the depressed position of the target key 2a is lower than the muting position D2 (S40: No), the processing of S41 and S42 is skipped. After the processing of S40 to S42, the muting processing is terminated.

Next, a synthesizer 20 of the second embodiment will be described with reference to (a) of FIG. 8, (b) of FIG. 8, (a) of FIG. 9, and (b) of FIG. 9. In the synthesizer 1 of the first embodiment described above, according to the processing of S32 to S34 in (a) of FIG. 7, in a case where 15 milliseconds have elapsed since the sound generation of the musical note based on the first key 2a in the group list 102a is started, the group list 102a is cleared, so that the normal tone rather than the special tone is used for the musical notes based on the remaining keys 2a stored in the group list 102a.

In the synthesizer 20 of the second embodiment, in addition to the above, in a case where a key 2a is stored in the group list 102a and then the speed thereof becomes equal to or less than the first speed before the depressed position thereof reaches the sound generation start position Ds, that key 2a is deleted from the group list 102a and the normal tone is used for the musical note based on that key 2a. The same reference numerals are assigned to the same configurations as in the first embodiment described above, and detailed descriptions thereof are omitted.

(a) of FIG. 8 is a flowchart of the main processing in the second embodiment. In the main processing of the second embodiment, a grouping disable processing of S50 is executed between the grouping processing of S2 and the sound generation processing of S3. The details of the grouping disable processing will be described later with reference to (a) of FIG. 9.

(b) of FIG. 8 is a flowchart of the grouping processing in the second embodiment. In the grouping processing of the second embodiment, in a case where it is confirmed that the depressed position of the target key 2a is at or above the determination end position D4 (S11: Yes) in the processing of S11, it is confirmed whether a special disable flag of the target key 2a is on (S60).

The special disable flag is provided for each key 2a, and is a flag in which the state of whether to use the normal tone or the special tone for the musical note based on that key 2a is stored. In a case where the special disable flag is on, the normal tone is used for the musical note based on the corresponding key 2a, and in a case where the special disable flag is off, the special tone is used for the musical note based on the corresponding key 2a.

In the processing of S60, in a case where the special disable flag of the target key 2a is on (S60: Yes), the processing from S12 onward is executed. On the other hand, in the processing of S60, in a case where the special disable flag of the target key 2a is off (S60: No), the processing of S12 and S13 is skipped.

(a) of FIG. 9 is a flowchart of the grouping disable processing. The grouping disable processing is processing that sets the special disable flag of the target key 2a to on based on the speed of the target key 2a, and removes that key 2a from the group list 102a.

The grouping disable processing first confirms whether the information of the target key 2a is in the group list 102a (S70). In the processing of S70, in a case where it is confirmed that the information of the target key 2a is in the group list 102a (S70: Yes), it is confirmed whether the depressed position of the target key 2a is at or above the determination end position D4 and at or below the determination start position D3 (S71).

In the processing of S71, in a case where it is confirmed that the depressed position of the target key 2a is at or above the determination end position D4 and at or below the determination start position D3 (S71: Yes), it is confirmed whether the speed of the target key 2a, acquired in the processing of S1 in the main processing of (a) of FIG. 8 and (b) of FIG. 8, is equal to or less than the first speed (S72). In this embodiment, “0 m/s” is used as the first speed, but the first speed is not limited thereto, and may be equal to or greater than 0 m/s.

In the processing of S72, in a case where it is confirmed that the speed of the target key 2a is equal to or less than the first speed (S72: Yes), the special disable flag of the target key 2a is set to on (S73), and the information of the target key 2a is deleted from the group list 102a (S74). On the other hand, in a case where it is confirmed that the speed of the target key 2a is greater than the first speed (S72: No), the processing of S73 and S74 is skipped.

In the processing of S70, in a case where it is confirmed that the information of the target key 2a is not in the group list 102a (S70: No), the processing of S71 to S74 is skipped. Further, in the processing of S71, in a case where it is confirmed that the depressed position of the target key 2a is lower than the determination end position D4 or higher than the determination start position D3 (S71: No), the processing of S72 to S74 is skipped. After the processing of S70, S71, S72, and S74, the grouping disable processing is terminated.

(b) of FIG. 9 is a flowchart of the muting processing in the second embodiment. In the muting processing of the second embodiment, in the processing of S41, in a case where it is confirmed that the musical note based on the target key 2a is being generated (S41: Yes), the special disable flag of the target key 2a is set to off (S80), and the processing of S42 described above is executed.

As described above, in the synthesizer 20 of the second embodiment, in a case where the depressed position of the target key 2a is at or above the determination end position D4, and the speed of the target key 2a becomes equal to or less than the first speed before the depressed position reaches the sound generation start position Ds which is at or below the determination start position D3, the target key 2a is deleted from the group list 102a (key group). As a result, in a case where the depressed position of the target key 2a subsequently reaches the sound generation start position Ds, the normal tone rather than the special tone is used for the musical note of that key 2a.

In other words, even in a case where the target key 2a is stopped with a speed equal to or less than the first speed while being depressed, for example, in a case where the user H has a “habit” of continuing to lightly depress the key 2a, the key 2a depressed due to that habit is deleted from the group list 102a (key group). As a result, even if the depressed position of that key 2a reaches the sound generation start position Ds, the normal tone is used for the musical note of that key 2a, so a situation that a musical note with the special tone is generated due to an unconscious or unexpected habit of the user H can be suppressed.

In addition, in a case where the speed of the target key 2a becomes equal to or less than the first speed even once during the period from when the target key 2a is depressed, and the depressed position thereof becomes higher than the muting position D2, until the target key 2a is released, the special disable flag becomes on, and the addition of the information of the target key 2a to the group list 102a is omitted. This can prevent the information of the target key 2a from being erroneously added to the group list 102a even if the depressed position of the target key 2a comes between the determination start position D3 and the determination end position D4 after the speed of the target key 2a becomes equal to or less than the first speed.

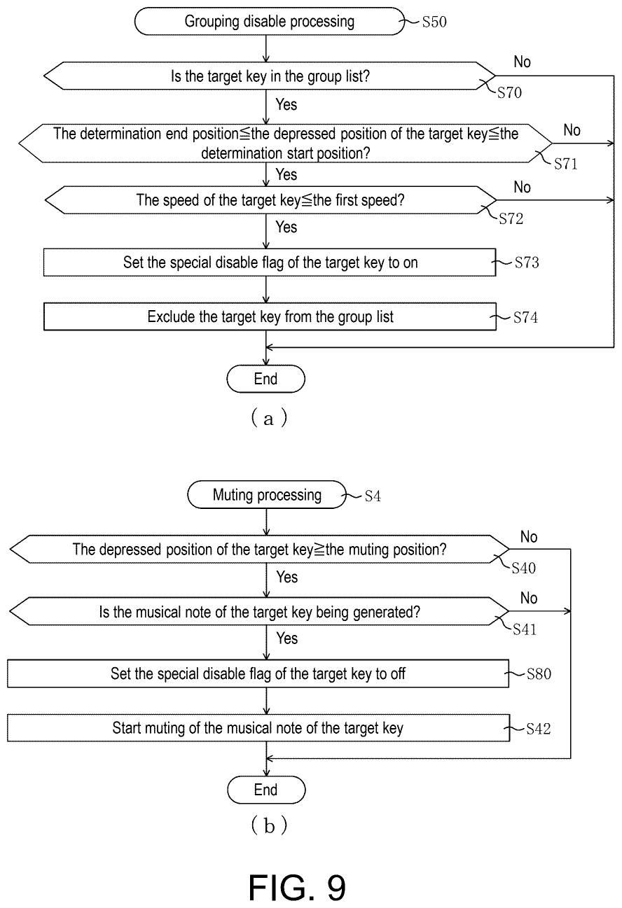

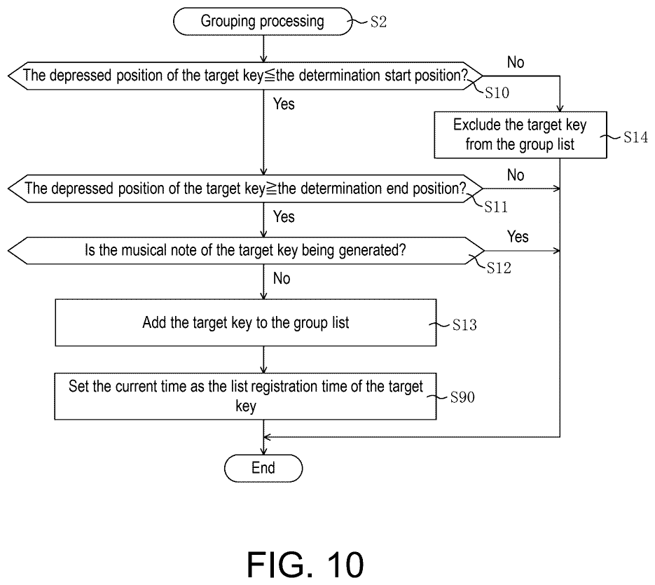

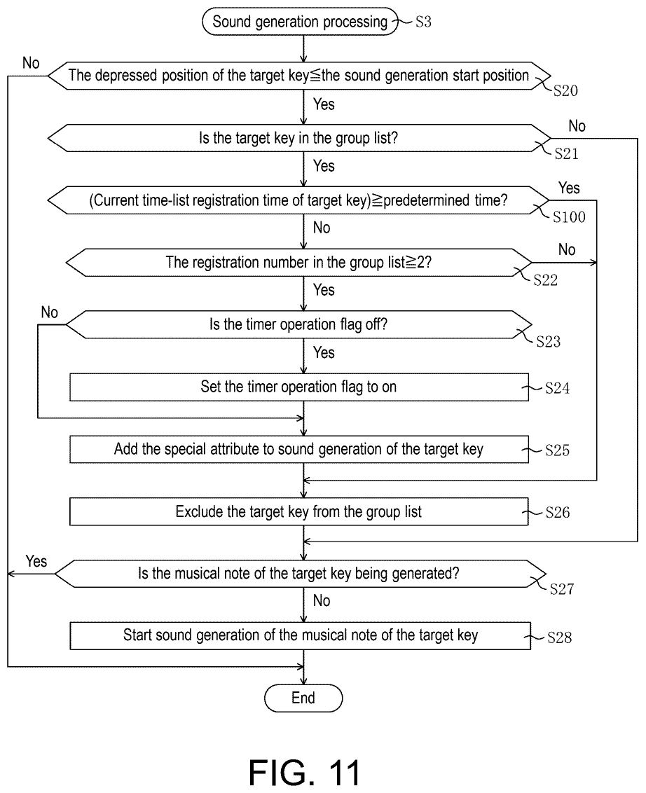

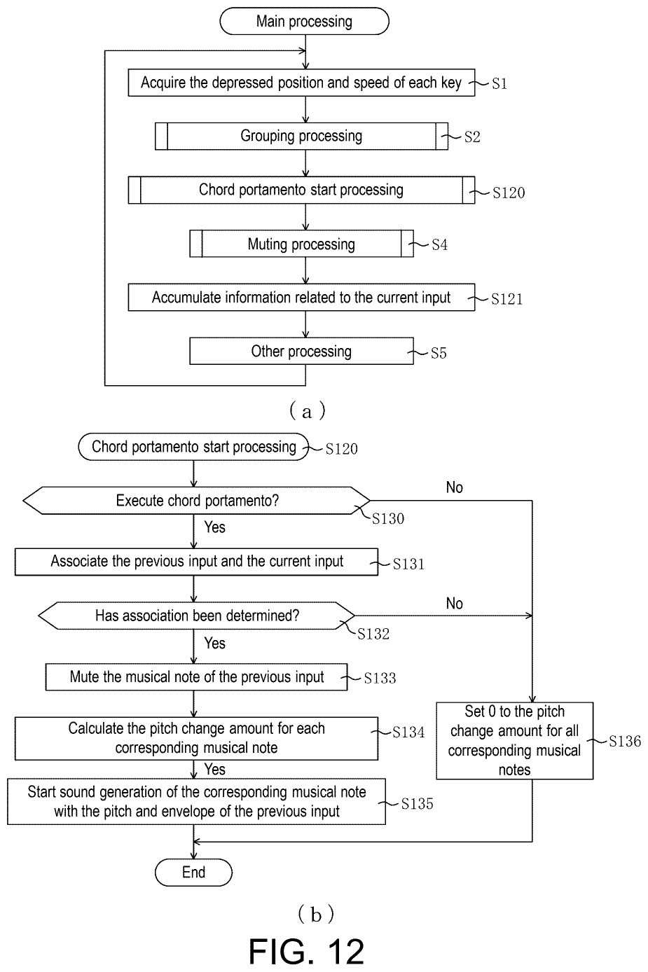

Next, a synthesizer 30 of the third embodiment will be described with reference to FIG. 10 and FIG. 11. In the synthesizer 30 of the third embodiment, in addition to the synthesizer 1 of the first embodiment described above, in a case where a predetermined time (10 milliseconds) has elapsed since a key 2a is stored in the group list 102a, that key 2a is deleted from the group list 102a, and the normal tone is used for the musical note based on that key 2a. The same reference numerals are assigned to the same configurations as in the first and second embodiments described above, and detailed descriptions thereof are omitted.

FIG. 10 is a flowchart of the grouping processing in the third embodiment. In the grouping processing of the third embodiment, after the processing of S13, the current time is set as a list registration time of the target key 2a (S90), and the grouping processing is terminated.

The list registration time is provided for each key 2a, and the time when the information of that key 2a is stored in the group list 102a is stored. The current time used in the processing of S90 and the processing of S100 in FIG. 11 to be described later may be obtained from an RTC (Real Time Clock) (not shown), or may be obtained from other means such as an NTP (Network Time Protocol) server.

FIG. 11 is a flowchart of the sound generation processing in the third embodiment. In the sound generation processing of the third embodiment, in a case where it is confirmed that the information of the target key 2a is in the group list 102a (S21: Yes) in the processing of S21 described above, it is confirmed whether the time difference between the current time and the list registration time of the target key 2a is equal to or greater than a predetermined time (second time) (S100). In this embodiment, “10 milliseconds” is set as the predetermined time in the processing of S100. The predetermined time in the processing of S100 is not limited to 10 milliseconds, and may be more than 10 milliseconds or less than 10 milliseconds.

In the processing of S100, in a case where it is confirmed that the time difference between the current time and the list registration time of the target key 2a is shorter than the predetermined time (S100: No), the processing of S22 to S26 onward is executed. On the other hand, in the processing of S100, in a case where it is confirmed that the time difference between the current time and the list registration time of the target key 2a is equal to or greater than the predetermined time (S100: Yes), the processing of S22 to S25 is skipped, and the information of the target key 2a is excluded from the group list 102a by the processing of S26 described above.

Thus, in the synthesizer 30 of the third embodiment, in a case where the depressed position of the target key 2a does not reach the sound generation start position Ds, and the time since the information of the target key 2a is stored in the group list 102a becomes equal to or greater than the predetermined time, the information of that key 2a is deleted from the group list 102a, and no special attribute is added to the sound generation of that key 2a. That is, in a case where the depressed position of the target key 2a, which has been stored in the group list 102a for the predetermined time or longer, reaches the sound generation start position Ds, the normal tone is used for the musical note based on that key 2a. This allows the user H to easily specify the tone to be used for the musical note based on that key 2a, among the normal tone and the special tone, by adjusting the timing of pushing the depressed position of the target key 2a to or below the sound generation start position Ds.

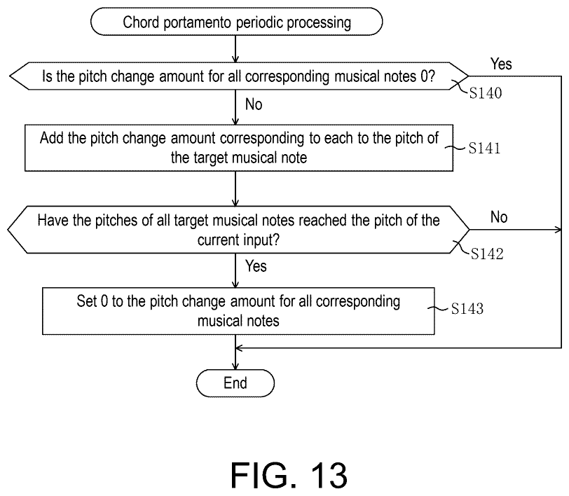

Next, a synthesizer 40 of the fourth embodiment will be described with reference to (a) of FIG. 12, (b) of FIG. 12, and FIG. 13. In the first to third embodiments, the special processing is executed as processing that uses a special tone different from the normal tone normally assigned for the musical note based on a key 2a. In contrast, in the synthesizer 40 of the fourth embodiment, sound generation of a musical note by chord portamento (polyphonic portamento) is executed as the special processing. The same reference numerals are assigned to the same configurations as in the first to third embodiments described above, and detailed descriptions thereof are omitted.

(a) of FIG. 12 is a flowchart of the main processing in the fourth embodiment. In the main processing of the fourth embodiment, chord portamento start processing (S120) is executed instead of the sound generation processing of S3. The chord portamento start processing will be described later in (b) of FIG. 12. After the chord portamento start processing, the muting processing (S4) is executed, and information related to the current input is accumulated (S121). Examples of the information stored in the processing of S121 include parameters related to musical notes such as pitch and envelope of the musical note based on the key 2a of the current input. After the processing of S121, the processing of S5 described above is executed.

Here, “current input” in the processing of S121 refers to a series of keys 2a that are stored in the group list 102a due to the user H depressing the keys 2a from a state where no information of key 2a is stored in the group list 102a. In contrast, “previous input” refers to a series of keys 2a that are stored in the group list 102a due to the user H depressing the keys 2a from a state where no information of key 2a is stored in the group list 102a, before the keys 2a in the current input are depressed.

It should be noted that the current input and the previous input are not necessarily set with multiple keys 2a corresponding to component sounds of a chord, but may also be set with multiple keys 2a corresponding to sounds that do not constitute a chord.

(b) of FIG. 12 is the chord portamento start processing. The chord portamento start processing is processing that starts sound generation of portamento by chord based on the keys 2a stored in the group list 102a.

The chord portamento start processing first confirms whether portamento by chord is to be executed (S130). In the processing of S130, specifically, it is confirmed whether two or more keys 2a are depressed in both the previous input and the current input. It should be noted that whether portamento by chord is to be executed is not necessarily determined by whether two or more keys 2a are depressed, but may also be determined, for example, by whether two or more keys 2a are depressed in both the previous input and the current input, and furthermore, whether the numbers of keys 2a depressed in these inputs are the same.

In the processing of S130, in a case where it is confirmed that portamento by chord is to be executed (S130: Yes), the keys 2a in the previous input and the keys 2a in the current input are associated with each other (S131). Specifically, the keys 2a in the previous input and the keys 2a in the current input are each sorted in order of pitch, and it is determined whether the keys 2a in the previous input after sorting and the keys 2a in the current input after sorting all correspond one-to-one.

For example, in a case where the keys 2a in the previous input correspond to “do,” “mi,” and “so” respectively, and the keys 2a in the current input correspond to “re,” “fa,” and “la” respectively, the key 2a of “do” in the previous input corresponds one-to-one with the key 2a of “re” in the current input, the key 2a of “mi” in the previous input corresponds one-to-one with the key 2a of “fa” in the current input, and the key 2a of “so” in the previous input corresponds one-to-one with the key 2a of “la” in the current input. In such a case, it is determined that the keys 2a in the previous input and the keys 2a in the current input all correspond one-to-one.

On the other hand, in a case where the number of keys 2a in the previous input is three and the number of keys 2a in the current input is four, or in other cases where the number of depressed keys 2a differs between the previous input and the current input, it is determined that there is no one-to-one relationship.

After the processing of S131, it is confirmed whether it has been determined that the previous input and the current input all correspond one-to-one (S132). In the processing of S132, in a case where it is determined that the previous input and the current input all correspond one-to-one (S132: Yes), the musical notes based on the keys 2a of the previous input are muted (S133).

After the processing of S134, the pitch change amount for each corresponding musical note is calculated (S132). Here, “corresponding musical note” refers to each musical note that is generated by portamento. For example, in a case where the keys 2a in the previous input correspond to “do,” “mi,” and “so” respectively, and the keys 2a in the current input correspond to “re,” “fa,” and “la” respectively, “do” in the previous input or “re” in the current input is the corresponding musical note with the lowest pitch, “mi” in the previous input or “fa” in the current input is the corresponding musical note with the second lowest pitch, and “so” in the previous input or “la”in the current input is the corresponding musical note with the highest pitch.

In addition, the “pitch change amount” is the amount of change per unit time (for example, 10 milliseconds) when changing from the pitch of the musical note in the previous input, which has been determined to correspond, to the pitch of the musical note in the current input over a change time (for example, 1 second). The unit time is set to the same time as the time interval at which chord portamento periodic processing is executed, which will be described later in FIG. 13.

For example, in a case where the keys 2a in the previous input correspond to “do,” “mi,” and “so” respectively, and the keys 2a in the current input correspond to “re,” “fa,” and “la” respectively, the pitch change amount for the corresponding musical note with the lowest pitch is set to the value obtained by subtracting the pitch corresponding to “do” in the previous input from the pitch corresponding to “re” in the current input, dividing that subtraction value by the above-mentioned change time, and then multiplying that division value by the above-mentioned unit time.

Similarly, the pitch change amount for the corresponding musical note with the second lowest pitch is set to the value obtained by subtracting the pitch corresponding to “mi” in the previous input from the pitch corresponding to “fa” in the current input, dividing that subtraction value by the above-mentioned change time, and then multiplying that division value by the above-mentioned unit time. The pitch change amount for the corresponding musical note with the highest pitch is set to the value obtained by subtracting the pitch corresponding to “so” in the previous input from the pitch corresponding to “la” in the current input, dividing that subtraction value by the above-mentioned change time, and then multiplying that division value by the above-mentioned unit time.

After the processing of S134, sound generation of the corresponding musical note is started with the pitch and envelope of the musical note based on the key 2a of the previous input (S135). The pitch and envelope of the musical note based on the key 2a of the previous input are obtained from the information accumulated in the processing of S121 described above. By the processing of S135, the sound generation is started as a musical note based on the key 2a of the previous input, before changing the corresponding musical note to a musical note based on the key 2a of the current input. The pitch of the corresponding musical note after this is changed in the chord portamento periodic processing which will be described later in FIG. 13.

In a case where it is confirmed that portamento by chord is not executed in the processing of S130 (S130: No), or in a case where it is determined that the previous input and the current input do not all correspond one-to-one in the processing of S132 (S132: No), 0 is set to the pitch change amount for all corresponding musical notes (S136). After the processing of S135 and S136, the chord portamento start processing is terminated.

FIG. 13 is a flowchart of the chord portamento periodic processing in the fourth embodiment. The chord portamento periodic processing is processing executed periodically every 10 milliseconds, and is processing that changes the pitch of each corresponding musical note to the pitch of the musical note based on each key 2a of the current input. It should be noted that the time interval at which the chord portamento periodic processing is executed is set to the same time as the unit time described above in (b) of FIG. 12.

The chord portamento periodic processing first confirms whether the pitch change amount for all corresponding musical notes is 0 (S140). In a case where it is confirmed that the pitch change amount for all corresponding musical notes is not 0 in the processing of S140 (S140: No), the pitch change amount corresponding to each is added to the pitch of the corresponding musical note (S141). This changes the pitch of the corresponding musical note, which is set to the pitch of the musical note based on the key 2a of the previous input, toward the pitch of the musical note based on the key 2a of the current input.

After the processing of S141, it is confirmed whether the pitches of all corresponding musical notes have reached the pitch of the corresponding musical note based on the key 2a of the current input (S142). In a case where it is confirmed that the pitches of all corresponding musical notes have reached the pitch of the corresponding musical note based on the key 2a of the current input in the processing of S142 (S142: Yes), 0 is set to the pitch change amount for all corresponding musical notes (S143).

In the processing of S142, in a case where it is confirmed that the pitches of all corresponding musical notes have not reached the pitch of the corresponding musical note based on the key 2a of the current input (S142: No), the processing of S143 is skipped. Also, in a case where it is confirmed that the pitch change amount for all corresponding musical notes is 0 in the processing of S140 (S140: No), the processing of S141 to S143 is skipped. After the processing of S140, S142, and S143, the chord portamento periodic processing is terminated.

As described above, in the synthesizer 40 of the fourth embodiment, portamento by chord (polyphonic portamento) is executed, as the special processing, to smoothly change each pitch of musical notes based on multiple keys 2a of the previous input to each pitch of corresponding musical notes based on multiple keys 2a of the current input. This allows the user H to realize a performance style that simultaneously and smoothly changes each of multiple musical notes as described above through a simple operation of depressing multiple keys 2a as the previous input and then depressing multiple keys 2a as the current input.

Although the disclosure has been described based on the above embodiments, it can be easily inferred that various improvements and changes are possible.

Although the first to fourth embodiments respectively illustrate the synthesizers 1, 20, 30, and 40, a synthesizer may be configured by appropriately combining the functions of the synthesizers 1, 20, 30, and 40. For example, a synthesizer may be configured by combining the functions of the synthesizer 30 of the third embodiment with the synthesizer 20 of the second embodiment, or a synthesizer may be configured by combining the functions of the synthesizer 40 of the fourth embodiment with the synthesizer 20 of the second embodiment or the synthesizer 30 of the third embodiment. Also, a synthesizer may be configured by combining the functions of the synthesizer 20 of the second embodiment and/or the functions of the synthesizer 30 of the third embodiment with the functions of the synthesizer 40 of the fourth embodiment.

In the first to third embodiments, the normal tone in the normal processing is set as piano, and the special tone in the special processing is set as organ, but the disclosure is not limited thereto. For example, the normal tone may be set as acoustic guitar and the special tone may be set as electric guitar, or other tones may be set as the normal tone and the special tone. Also, it may be configured so that the user H can set the normal tone and the special tone through the setting keys P.

In addition, the special processing may be processing that uses an acoustic effect (for example, reverb) used for musical notes that is different from the acoustic effect (for example, delay) used for musical notes in the normal processing. Alternatively, the special processing may be processing that makes the parameters constituting musical notes (for example, attack, decay, sustain or release, or cutoff frequency) different from the parameters constituting musical notes used in the normal processing.

Also, in the fourth embodiment, the special processing is processing that generates sound of musical notes by chord portamento based on the keys 2a registered to the key group, but the disclosure is not limited thereto. For example, the special processing may be processing that generates sound of musical notes by arpeggio based on the keys 2a registered to the key group, or processing that generates sound of musical notes by strumming based on the keys 2a registered to the key group. Alternatively, processing that executes other performance techniques based on the keys 2a registered to the key group may be used as the special processing.

Furthermore, the special processing is not limited to the processing related to the sound generation of musical notes described above, but may be processing that recognizes the chord of the keys 2a registered to the key group. In this case, for example, if keys 2a corresponding to “do,” “mi,” and “so” are registered to the key group, it may be determined that a “C chord” has been depressed as a chord, and this may be displayed on a display device (not shown). Also, processing that analyzes the keys 2a registered to the key group, other than chord recognition, may be used as the special processing.

In the above embodiments, in the processing of S34 in the timer processing ((a) of FIG. 7), the group list 102a is cleared to delete all information of the keys 2a stored in the group list 102a at that time, but the disclosure is not limited thereto. For example, in the processing of S34, the information of the key 2a that has been stored in the group list 102a for the longest time among the information of the keys 2a stored in the group list 102a may be deleted, or any other information of the keys 2a stored in the group list 102a may be deleted.

In addition, by excluding the processing of S34 from the timer processing, the information of the keys 2a stored in the group list 102a may be maintained even if 15 milliseconds have elapsed since the sound generation of the musical note based on the first key 2a in the group list 102a is started. In this case, it is preferable to also exclude the processing of S23 and S24 in the sound generation processing of FIG. 6, as well as processing other than S34 in the timer processing.

In the above embodiments, the determination end position D4 is set at the same height as the sound generation start position Ds, but the disclosure is not limited thereto. The determination end position D4 may be set at a position higher than the sound generation start position Ds as long as the determination end position D4 is lower than the determination start position D3.

Furthermore, in the above embodiments, the determination start position D3 and the determination end position D4 are set at fixed positions, but the disclosure is not limited thereto. It may be configured to allow the user H to set the determination start position D3 and the determination end position D4 via the setting keys P. By allowing the user H to set the determination start position D3 and the determination end position D4 in this way, the user H can adjust the ease of registering the keys 2a to the key group based on “habits” of the user H. This makes it possible to register a key 2a to the key group according to the intention of the user H, and execute the special processing based on that key 2a.

In the above embodiments, the determination start position D3 is set at a position lower than the muting position D2, but the disclosure is not limited thereto. The determination start position D3 may be set at a position higher than the muting position D2, or may be set at the same position as the muting position D2 as long as the determination start position D3 is lower than the key release position D1.

In the above embodiments, the control program 101a is stored in the flash ROM 101 of the synthesizer 1 and configured to operate on the synthesizers 1, 20, 30, and 40, but the disclosure is not limited thereto. The control program 101a may be configured to operate on other electronic musical instruments such as electronic piano. Additionally, the control program 101a may be configured to operate on other computers such as PC (personal computer), mobile phone, smartphone, or tablet terminal. In this case, a keyboard device with a configuration similar to the keyboard 2 may be connected to the PC, mobile phone, etc.

What is claimed is:

1. An electronic musical instrument, comprising a keyboard having a plurality of keys, the electronic musical instrument comprising:
a hardware processor configured to function as:
a registration part that, after a key is depressed, registers the key to a key group in a case where a depressed position of the key is between a determination start position and a determination end position which is a position lower than the determination start position;
a normal processing execution part that, in a case where a depressed position of a key not registered to the key group reaches an execution start position which is a position at or below the determination end position, or in a case where a depressed position of a key registered to the key group reaches the execution start position in a state where the number of keys registered to the key group is one, executes normal processing based on these keys; and
a special processing execution part that, in a case where a depressed position of a key registered to the key group reaches the execution start position in a state where the number of keys registered to the key group is two or more, executes special processing which is special processing based on the key and is different from the normal processing.

2. The electronic musical instrument according to claim 1, wherein in a case where the depressed position of the key is between the determination start position and the determination end position, and a musical note based on the key is not being generated, the registration part registers the key to the key group.

3. The electronic musical instrument according to claim 1, wherein the hardware processor is further configured to function as:
an exclusion part that, in a case where a depressed position of a key registered to the key group reaches the execution start position, excludes the key from the key group.

4. The electronic musical instrument according to claim 1, wherein the hardware processor is further configured to function as:
an exclusion part that, in a case where a key registered to the key group is released and the depressed position of the key becomes higher than the determination start position, excludes the key from the key group.

5. The electronic musical instrument according to claim 1, wherein the hardware processor is further configured to function as:
an exclusion part that, in a case where a key is registered by the registration part to the key group in an unregistered state and then a first time has elapsed since a depressed position of any key registered to the key group first reaches the execution start position, excludes the key registered to the key group at that point from the key group.

6. The electronic musical instrument according to claim 1, wherein the hardware processor is further configured to function as:
an exclusion part that, in a case where a speed of a key registered to the key group becomes equal to or less than a first speed before a depressed position of the key reaches the execution start position, excludes the key from the key group.

7. The electronic musical instrument according to claim 1, wherein the hardware processor is further configured to function as:
an exclusion part that, in a case where a second time has elapsed since a key is registered to the key group among keys registered to the key group, excludes the key from the key group.

8. The electronic musical instrument according to claim 1, wherein the determination end position is set at a same height as the execution start position.

9. The electronic musical instrument according to claim 1, wherein the determination start position and the determination end position are configured to be settable by a user.

10. The electronic musical instrument according to claim 1, wherein the normal processing generates a musical note based on a key whose depressed position reaches the execution start position, and
the special processing generates a musical note based on a key whose depressed position reaches the execution start position with a tone different from the musical note generated by the normal processing.

11. The electronic musical instrument according to claim 1, wherein the special processing generates a musical note by arpeggio based on a key registered to the key group.

12. The electronic musical instrument according to claim 1, wherein the special processing generates a musical note by strumming based on a key registered to the key group.

13. The electronic musical instrument according to claim 1, wherein the special processing generates a musical note by portamento based on a key registered to the key group.

14. The electronic musical instrument according to claim 1, wherein the special processing performs chord recognition on a key registered to the key group.

15. A processing execution method, executed in an electronic musical instrument comprising a keyboard having a plurality of keys, the processing execution method comprising:
a registration step, after a key is depressed, registering the key to a key group in a case where a depressed position of the key is between a determination start position and a determination end position which is a position lower than the determination start position;
a normal processing execution step, in a case where a depressed position of a key not registered to the key group reaches an execution start position which is a position at or below the determination end position, or in a case where a depressed position of a key registered to the key group reaches the execution start position in a state where the number of keys registered to the key group is one, executing normal processing based on these keys; and
a special processing execution step, in a case where a depressed position of a key registered to the key group reaches the execution start position in a state where the number of keys registered to the key group is two or more, executing special processing which is special processing based on the key and is different from the normal processing.

16. A non-transitory storage medium, storing a processing execution program, wherein the processing execution program causes a computer comprising a keyboard having a plurality of keys to execute processing based on the key depressed, the processing execution program causing the computer to execute:
a registration step, after a key is depressed, register the key to a key group in a case where a depressed position of the key is between a determination start position and a determination end position which is a position lower than the determination start position;
a normal processing execution step, in a case where a depressed position of a key not registered to the key group reaches an execution start position which is a position at or below the determination end position, or in a case where a depressed position of a key registered to the key group reaches the execution start position in a state where the number of keys registered to the key group is one, execute normal processing based on these keys; and
a special processing execution step, in a case where a depressed position of a key registered to the key group reaches the execution start position in a state where the number of keys registered to the key group is two or more, execute special processing which is special processing based on the key and is different from the normal processing.

17. The electronic musical instrument according to claim 2, wherein the determination end position is set at a same height as the execution start position.

18. The electronic musical instrument according to claim 2, wherein the determination start position and the determination end position are configured to be settable by a user.

19. The electronic musical instrument according to claim 2, wherein the normal processing generates a musical note based on a key whose depressed position reaches the execution start position, and
the special processing generates a musical note based on a key whose depressed position reaches the execution start position with a tone different from the musical note generated by the normal processing.

20. The electronic musical instrument according to claim 3, wherein the determination end position is set at a same height as the execution start position.
